(19) United States
(12) Patent Application Publication
(10) Pub. No.: US 2020/0357375 A1
(43) Pub. Date: Nov. 12, 2020

(54) PROACTIVE SOUND DETECTION WITH NOISE CANCELLATION COMPONENT WITHIN EARPHONE OR HEADSET

(71) Applicant: MEDIATEK INC., Hsin-Chu (TW)

(72) Inventors: Kuan-Ta Chen, Hsin-Chu (TW); Nien-Hui Kung, San Jose, CA (US); Jing-Meng Liu, Hsinchu County (TW)

(21) Appl. No.: 16/833,688

(22) Filed: Mar. 30, 2020

Related U.S. Application Data
(60) Provisional application No. 62/843,636, filed on May 6, 2019.

(51) Int. Cl. G10K 11/178

(52) U.S. Cl. CPC G10K 11/17837

(57) ABSTRACT

The present invention provides a device including a sound detector and a noise cancellation component. In the operations of the device, the sound detector is configured to receive an environment sound obtained from a microphone, and determine if the environment sound has a meaningful signal or not to generate a detection result; and the noise cancellation component is configured to perform a noise cancellation operation based on the detection result to generate an output signal to a speaker.

### CROSS REFERENCE TO RELATED APPLICATIONS

This application claims the priority of U.S. Provisional Application No. 62/843,636, filed on May 6, 2019, which is included herein by reference in its entirety.

### BACKGROUND

An earphone or a headset generally has a noise-cancellation component to eliminate environment noise so that user can avoid interference when listening to music. However, in the process of eliminating environmental noise, the user may not hear important sounds from the environment. For example, honk of horn, ambulance warning sounds, name of the user or other important sounds may not be filtered out by the noise-cancellation component, causing dangerous or inconvenience to the user.

### SUMMARY

It is therefore an objective of the present invention to provide a device capable of the eliminate the meaningless noise of the environment sound while retaining meaningful signal for the user, to solve the above-mentioned problems.

According to one embodiment of the present invention, a device comprising a sound detector and a noise cancellation component is disclosed. In the operations of the device, the sound detector is configured to receive an environment sound obtained from a microphone, and determine if the environment sound has a meaningful signal or not to generate a detection result; and the noise cancellation component is configured to perform a noise cancellation operation based on the detection result to generate an output signal to a speaker.

According to another embodiment of the present invention, a signal processing method comprises the steps of: receiving an environment sound obtained from a microphone; determining if the environment sound has a meaningful signal or not to generate a detection result; and performing a noise cancellation operation based on the detection result to generate an output signal to a speaker.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a device according to one embodiment of the present invention.

FIG. 2 is a diagram illustrating a device according to one embodiment of the present invention.

FIG. 3 is a diagram illustrating a device according to one embodiment of the present invention.

FIG. 4 is a flowchart of a signal processing method according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

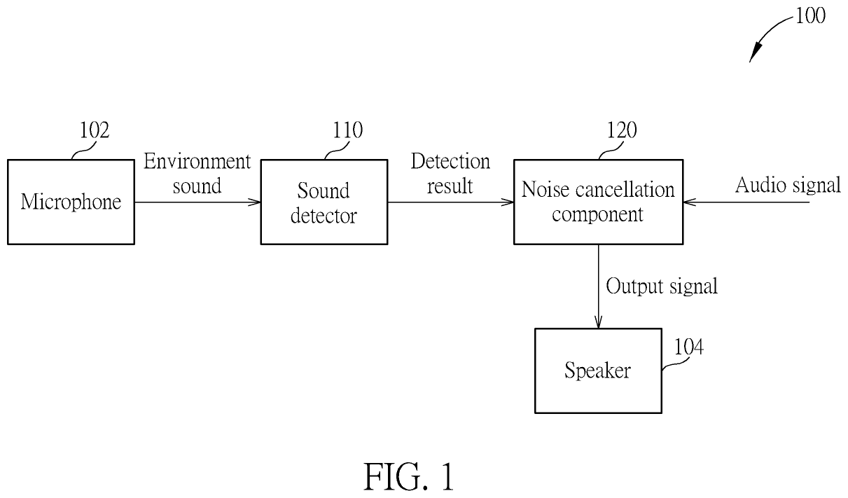

FIG. 1 is a diagram illustrating a device 100 according to one embodiment of the present invention, wherein the device 100 may be comprised in an earphone or a headset. As shown in FIG. 1, the device 100 comprises a microphone 102, a sound detector 110, a noise cancellation component 120 and a speaker 104.

In the operations of the device 100, the microphone 102 continuously receives the ambient sound (environment sound), and the sound detector 110 receives the environment sound from the microphone 102. The sound detector 110 detects that if the environment sound has a meaningful signal or not to generate a detection result. In this embodiment, the meaningful signal(s) can be defined and established in a table within the device 100, wherein the meaningful signal(s) may comprise warning tones such as honk of horn and ambulance warning sounds, or a specific voice such as a user name. The noise cancellation component 120 performs a noise cancellation operation based on the detection result to generate an output signal to the speaker 104, to make the user only hear the meaningful signal of the environment sound, and the meaningless noise of the environment sound will not be heard by the user.

In addition, when the user uses the device 100 to listen to music, the noise cancellation component 120 may also receive the audio signal (i.e. music), and the output signal generated by the noise cancellation component 120 may also comprise the audio signal, so that the user can hear the music and the meaningful signal simultaneously. In another embodiment, when the detection result indicates that one or more meaningful signals are in the environment sound, the noise cancellation component 120 may block the audio signal (i.e., the music playback is interrupted), or reduce the strength/volume of the audio signal so that the user can clearly hear the meaningful signal(s).

By using the above signal processing mechanism, because the noise cancellation component 120 is only configured to eliminate the meaningless noise of the environment sound, the user can clearly hear the meaningful signal(s) even if the environment sound is continuously under the noise cancellation operation. Therefore, by using the device 100, the user can avoid possible dangers while listening to the music.

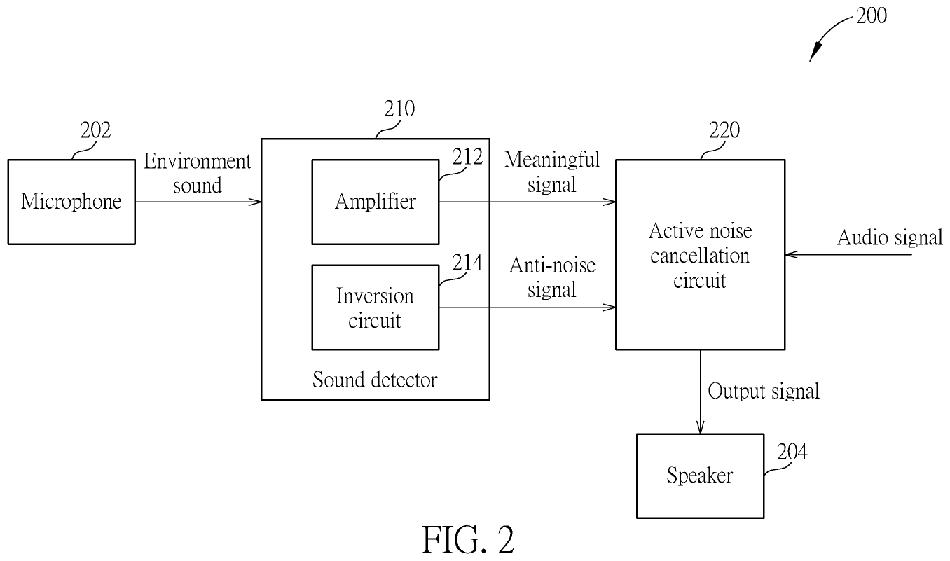

FIG. 2 is a diagram illustrating a device 200 according to one embodiment of the present invention, wherein the device 200 may be comprised in an earphone or a headset. As shown in FIG. 2, the device 200 comprises a microphone 202, a sound detector 210, a noise cancellation component (in this embodiment, the noise cancellation component is an active noise cancellation circuit 220) and a speaker 204, wherein the sound detector 210 comprises an amplifier 212 and an inversion circuit 214.

In the operations of the device 200, the microphone 202 continuously receives the ambient sound (environment sound), and the sound detector 210 receives the environment sound from the microphone 202. The sound detector 210 detects that if the environment sound has a meaningful signal or not, and generates a detection result comprising the meaningful signal, if any, and the anti-noise signal to the active noise cancellation circuit 220. In this embodiment, the meaningful signal can be extracted from the environment sound by using any sound recognition technique, and the meaningful signal may be amplified by using the amplifier 212; and the meaningless noise (e.g., the part of the environment sound other than the meaningful signal) is processed by the inversion circuit 214 to generate the anti-noise signal, wherein the anti-noise signal and the meaningless noise may have the similar intensity but opposite phases. In this embodiment, the meaningful signal(s) can be defined and established in a table within the device 200, wherein the meaningful signal(s) may comprise warning tones such as honk of horn and ambulance warning sounds, or a specific voice such as a user name. The active noise cancellation circuit 220 performs a noise cancellation operation based on the detection result to generate an output signal to the speaker 204, wherein the output signal may comprise the meaningful signal and the anti-noise signal. Therefore, because the output signal comprises the anti-noise signal whose phase is opposite to the meaningless noise of the environment sound, the user can only hear the meaningful signal of the environment sound, and the meaningless noise of the environment sound will not be heard by the user (because the meaningless noise and the anti-noise signal are cancelled out).

In addition, when the user uses the device 200 to listen to music, the active noise cancellation circuit 220 may also receive the audio signal (i.e. music), and the active noise cancellation circuit 220 may generate the output signal by combining the audio signal, the meaningful signal and the anti-noise signal, so that the user can hear the music and the meaningful signal simultaneously. In another embodiment, when the detection result indicates that one or more meaningful signals are in the environment sound, the active noise cancellation circuit 220 may block the audio signal (i.e., the music playback is interrupted), or reduce the strength/volume of the audio signal, so that the user can clearly hear the meaningful signal(s).

In the embodiment shown in FIG. 2, the detection result generated by the sound detector comprises the meaningful signal, however, it is not a limitation of the present invention. In another embodiment, the detection result may merely comprise the anti-noise signal, and the user can also hear the meaningful signal of the environment sound coming through a case of the earphone or the headset.

By using the above signal processing mechanism, because the sound detector 210 generates the anti-noise signal by only using the meaningless signal of the environment sound (i.e. the meaningful signal is not processed by the inversion circuit 214), the user can clearly hear the meaningful signal(s) even if the environment sound is continuously under the noise cancellation operation. Therefore, by using the device 200, the user can avoid possible dangers while listening to the music.

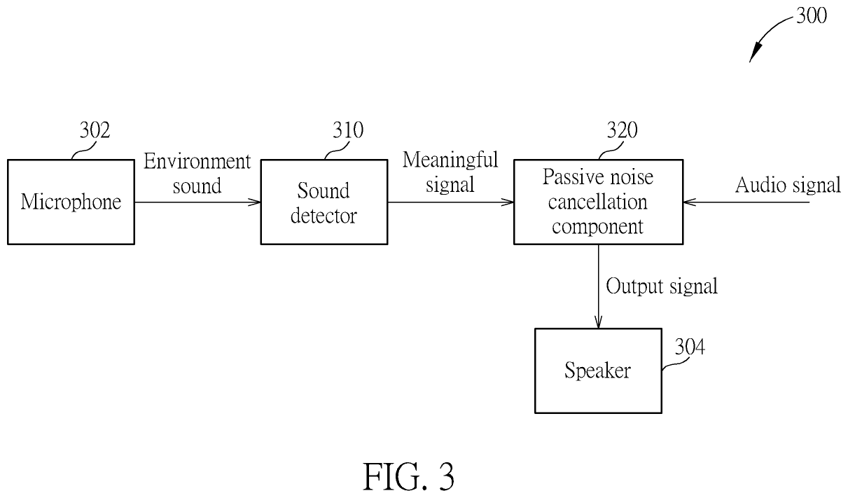

FIG. 3 is a diagram illustrating a device 300 according to one embodiment of the present invention, wherein the device 300 may be comprised in an earphone or a headset. As shown in FIG. 3, the device 300 comprises a microphone 302, a sound detector 310, a noise cancellation component (in this embodiment, the noise cancellation component is a passive noise cancellation component 320 such as earmuffs) and a speaker 304.

In the operations of the device 300, the microphone 302 continuously receives the ambient sound (environment sound), and the sound detector 310 receives the environment sound from the microphone 302. The sound detector 310 detects that if the environment sound has a meaningful signal or not, and generates a detection result comprising the meaningful signal, if any, to the passive noise cancellation component 320. In this embodiment, the meaningful signal can be extracted from the environment sound by using any sound recognition technique, and the meaningless noise (e.g., the part of the environment sound other than the meaningful signal) is filtered out by the sound detector 310 (i.e. the detection result does not comprise the meaningless noise). In this embodiment, the meaningful signal(s) can be defined and established in a table within the device 300, wherein the meaningful signal(s) may comprise warning tones such as honk of horn and ambulance warning sounds, or a specific voice such as a user name. The passive noise cancellation component 320 performs a noise cancellation operation based on the detection result to generate an output signal to the speaker 304, wherein the output signal comprises the meaningful signal. Therefore, the user can only hear the meaningful signal of the environment sound, and the meaningless noise of the environment sound will not be heard by the user.

In addition, when the user uses the device 300 to listen to music, the passive noise cancellation component 320 may also receive the audio signal (i.e. music), and the passive noise cancellation component 320 may generate the output signal by combining the audio signal and the meaningful signal, so that the user can hear the music and the meaningful signal simultaneously. In another embodiment, when the detection result indicates that one or more meaningful signals are in the environment sound, the passive noise cancellation component 320 may block the audio signal (i.e., the music playback is interrupted), or reduce the strength/volume of the audio signal, so that the user can clearly hear the meaningful signal(s).

By using the above signal processing mechanism, because the passive noise cancellation component 320 generates output signal having the meaningful signal without the meaningless noise, the user can clearly hear the meaningful signal(s) even if the environment sound is continuously under the noise cancellation operation. Therefore, by using the device 300, the user can avoid possible dangers while listening to the music.

In addition, the above embodiments can also be used in a hearing aid, and the meaningful signal(s) may comprise some specific voices (e.g. human voice), to make the user only hear what they need, without hearing the meaningless noise.

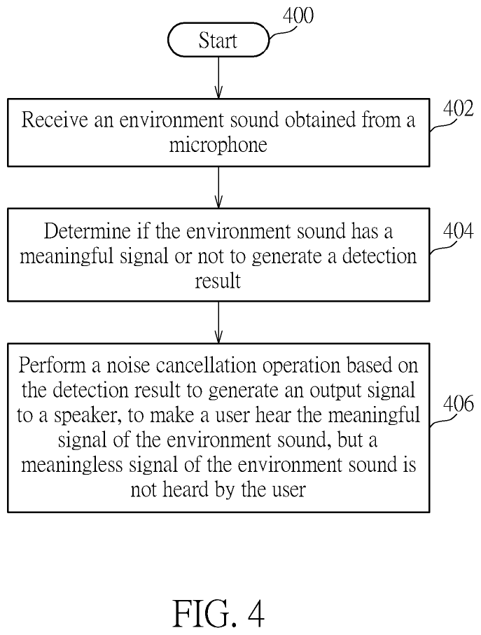

FIG. 4 is a flowchart of a signal processing method according to one embodiment of the present invention. Referring to the above embodiment, the flow is described as follows.

Step 400: the flow starts.

Step 402: receive an environment sound obtained from a microphone.

Step 404: determine if the environment sound has a meaningful signal or not to generate a detection result.

Step 406: perform a noise cancellation operation based on the detection result to generate an output signal to a speaker, to make a user hear the meaningful signal of the environment sound, but a meaningless signal of the environment sound is not heard by the user.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A device, comprising:
a sound detector, configured to receive an environment sound obtained from a microphone, and determine if the environment sound has a meaningful signal or not to generate a detection result; and
a noise cancellation component, coupled to the sound detector, configured to perform a noise cancellation operation based on the detection result to generate an output signal to a speaker.

2. The device of claim 1, wherein the environment sound has the meaningful signal and a meaningless noise, the noise cancellation component is an active noise cancellation circuit, and the noise cancellation component generates the output signal comprising an anti-noise signal of the meaningless noise.

3. The device of claim 2, wherein the sound detector comprises an inversion circuit to change a phase of the meaningless noise to generate the anti-noise signal comprised in the detection result, and the inversion circuit does not process of the meaningful signal as the meaningless noise.

4. The device of claim 3, wherein the noise cancellation component generates the output signal comprising the anti-noise signal of the meaningless noise and the meaningful signal of the environment sound.

5. The device of claim 3, wherein the noise cancellation component further receives an audio signal, and the noise cancellation component combines the audio signal and the anti-noise signal of the meaningless noise to generate the output signal.

6. The device of claim 3, wherein the noise cancellation component further receives an audio signal, and the noise cancellation component blocks the audio signal or reduce a volume of the audio signal; and the output signal generated by the noise cancellation component comprises the anti-noise signal of the meaningless noise without the audio signal, or the output signal comprises the anti-noise signal of the meaningless noise and a volume-reduced audio signal.

7. The device of claim 1, wherein the environment sound has the meaningful signal and a meaningless noise, the noise cancellation component is a passive noise cancellation component, and the sound detector generates the detection result comprising the meaningful signal to the noise cancellation component.

8. The device of claim 7, the sound detector filters output the meaningless noise, so that the sound detector generates the detection result only comprising the meaningful signal.

9. The device of claim 7, wherein the noise cancellation component further receives an audio signal, and the noise cancellation component combines the audio signal and the meaningful signal to generate the output signal.

10. The device of claim 7, wherein the noise cancellation component further receives an audio signal, and the noise cancellation component blocks the audio signal or reduce a volume of the audio signal; and the output signal generated by the noise cancellation component only comprises the meaningful signal, or the output signal comprises the meaningful signal and a volume-reduced audio signal.

11. The device of claim 1, wherein the meaningful signal comprises a warning tone.

12. The device of claim 1, wherein the meaningful signal comprises a specific voice defined by a user of the device.

13. A signal processing method, comprising:
receiving an environment sound obtained from a microphone;
determining if the environment sound has a meaningful signal or not to generate a detection result; and
performing a noise cancellation operation based on the detection result to generate an output signal to a speaker.

14. The signal processing method of claim 13, wherein the environment sound has the meaningful signal and a meaningless noise, and the step of performing the noise cancellation operation based on the detection result to generate the output signal to the speaker comprises:
performing the noise cancellation operation to generate the output signal comprising an anti-noise signal of the meaningless noise.

15. The signal processing method of claim 14, wherein the step of performing the noise cancellation operation to generate the output signal comprising the anti-noise signal of the meaningless noise comprises:
performing the noise cancellation operation to generate the output signal comprising the anti-noise signal of the meaningless noise and the meaningful signal of the environment sound.

16. The signal processing method of claim 13, wherein the environment sound has the meaningful signal and a meaningless noise, and the step of performing the noise cancellation operation based on the detection result to generate the output signal to the speaker comprises:
performing the noise cancellation operation to generate the output signal comprising only comprising the meaningful signal without the meaningless noise.

17. The signal processing method of claim 13, wherein the meaningful signal comprises a warning tone.

18. The signal processing method of claim 13, wherein the meaningful signal comprises a specific voice defined by a user of the device.
